(19) United States
(12) Patent Application Publication
(10) Pub. No.: US 2013/0151832 A1
(43) Pub. Date: Jun. 13, 2013

(54) FLASH MEMORY STORAGE SYSTEM AND DATA PROTECTION METHOD THEREOF

(71) Applicants: Chia-Yuan Chou, Hsinchu City (TW); Ching-Min Hou, Taichung City (TW)

(72) Inventors: Chia-Yuan Chou, Hsinchu City (TW); Ching-Min Hou, Taichung City (TW)

(73) Assignee: ITE Tech. Inc., Hsinchu (TW)

(21) Appl. No.: 13/368,341

(22) Filed: Feb. 8, 2012

(30) Foreign Application Priority Data
Dec. 8, 2011 (TW) 100145324

(51) Int. Cl. G06F 15/177

(52) U.S. Cl. 713/2

(57) ABSTRACT

A flash memory storage system includes a flash memory, a host and a controller is provided. The controller couples to the host and the flash memory, and restricts the host to access the flash memory according to a state of the host. When the host is in a booting state or in a resetting state, the controller allows the host to access the flash memory. After the host completes a booting process or a resetting process, the controller restricts the host to access the flash memory so as to protect a data stored by the flash memory. Besides, a data protection method for which applied to the above-mentioned storage system is also provided in the present invention.

### CROSS-REFERENCE TO RELATED APPLICATION

This application claims the priority benefit of Taiwan application serial no. 100145324, filed on Dec. 8, 2011. The entirety of the above-mentioned patent application is hereby incorporated by reference herein and made a part of this specification.

### BACKGROUND OF THE INVENTION

1. Field of the Invention

The present invention relates to a storage system and a data protection method thereof, and more particularly to a protection method for preventing a data of a flash memory being accessed maliciously and a flash memory storage system using the same.

2. Description of Related Art

In general computer system, the system performs a booting process by running the basic input and output system (BIOS) program stored in the flash memory, and the operating system is loaded. After the booting process is completed, the authorization of controlling the computer system is controlled by the operating system which completes a booting state, i.e. entering the state which can be controlled by general users, and users can input commands to the computer system and access the data of the system.

After the booting process is completed, users can input commands to the controller so as to read or write the data of the flash memory. However, once users want to modify, steal or destroy the important data (for example, BIOS) maliciously through the controller, the general computer system can not avoid the above-mentioned circumstances. Therefore, how to protect the data stored in the flash memory is a very important problem.

### SUMMARY OF THE INVENTION

The present invention is directed to a flash memory storage system, by which the host is restricted to access a specific data of a flash memory after completing the booting process, so as to prevent the specific data being tampered or destroyed maliciously.

The present invention is directed to a data protection method, by which the memory address of the specific data is protected, so that the memory address can not be read or written after the booting process is completed.

The present invention provides a flash memory storage system, which includes a flash memory, a host and a controller. The controller is coupled to the host and the flash memory and restricts the host to access the flash memory according to a state of the host. When the host is in a booting state or in a resetting state, the controller allows the host to access the flash memory. After the host completes a booting process or a resetting process, the controller restricts the host to access the flash memory.

In an embodiment of the present invention, the flash memory storage system further comprises a switch, which is coupled between a main power and the host and turns on the switch according to a suspension power, so as to supply the main power to the host.

In an embodiment of the present invention, when the controller is closed, the controller turns off the switch of the flash memory storage system to stop supplying the main power to the host.

In an embodiment of the present invention, when the host is in a resetting state controlled by a resetting signal, the controller allows the host to access the flash memory according to the resetting signal.

In an embodiment of the present invention, the flash memory storage system further comprises a clock generator. The clock generator is coupled to the host, provides a clock signal for an operation of the host, in which when the controller is closed, the clock generator stops providing the clock signal to the host.

In an embodiment of the present invention, the controller comprises at least a register, which stores a memory address of a protection block of the flash memory. The controller further obtains the memory address of the protection block from the flash memory and writes the memory address of the protection block into the register.

In an embodiment of the present invention, the controller further determines whether a target memory address which the host wants to access is the memory address of the protection block, if the target memory address is the memory address of the protection block, the controller denies the host to access the target memory address.

The present invention provides a data protection method for a flash memory storage system, where the flash memory storage system includes a host and a flash memory. The data protection method includes the following steps: determining whether the host is in a booting state or in a resetting state; allowing the host to access the flash memory, if the host is in the booting state or in the resetting state; and restricting the host to access the flash memory, if the host is not in the booting state or in the resetting state.

In an embodiment of the present invention, the step of restricting the host to access the flash memory further includes the following steps: determining whether a target memory address which the host wants to access is a memory address of a protection block; denying the host to access the target memory address, if the target memory address is the memory address of the protection block; and allowing the host to access the target memory address, if the target memory address is not the memory address of the protection block.

In an embodiment of the present invention, the flash memory storage system further includes a register, and the step of the host is in the booting state or in the resetting state further includes the following steps: obtaining a memory address of a protection block; and writing the memory address of the protection block into the register.

Based on the above descriptions, the flash memory storage system of the embodiment of the present invention sets the specific data area within the flash memory as the protection block, so that the controller writes the memory address of the protection block into the register and performs the access restrictions.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a flash memory storage system according to an embodiment of the present invention.

FIG. 2 is a flowchart illustrating a data protection method according to the embodiment of the FIG. 1.

FIG. 3 is a schematic diagram of a flash memory storage system according to another embodiment of the present invention.

FIG. 4 is a schematic diagram of a flash memory storage system according to another embodiment of the present invention.

### DESCRIPTION OF THE EMBODIMENTS

In the embodiment of the present invention, a plurality of flash memory storage systems having data protection function and a data protection method applied to the above-mentioned storage systems are provided, which not only prevent the specific data within the flash memory being accessed by general users inadvertently, but also prevent the specific data of the flash memory being stolen or prevent the systems being destroyed by malicious users. The description of the embodiments is completely disclosed in detail below.

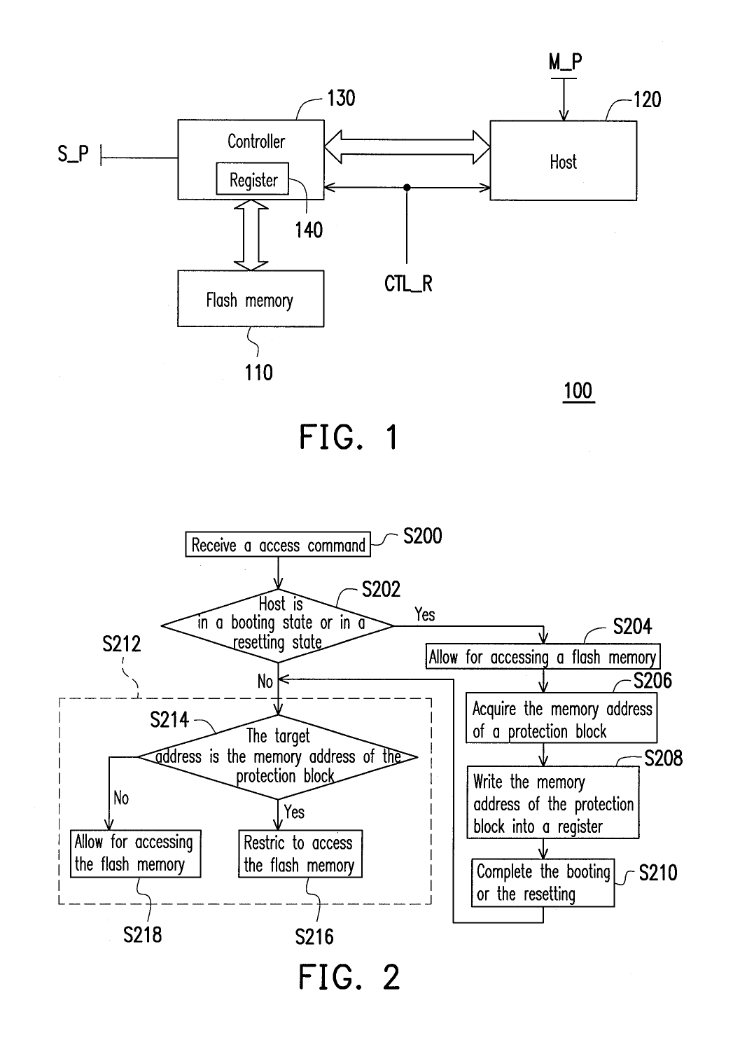

FIG. 1 is a schematic diagram of a flash memory storage system according to an embodiment of the present invention. Please referring to FIG. 1, a flash memory storage system 100 includes a flash memory 110, a host 120 and a controller 130 having a register 140. The flash memory storage system of the present invention is adapted for a variety of computer devices, for example, a desktop computer or a notebook, etc.

In the flash memory storage system 100, the controller 130 is coupled to the flash memory 110 and host 120. The controller 130 controls the host 120 to access the data of the flash memory 110, in which the flash memory storage system 100 defines a specific data storage area of the flash memory 110 as a protection block in advance; a main power M_P and a suspension power S_P are coupled to the host 120 and the controller 130 respectively, so as to supply the power of operation for the host 120 and the controller 130. In some embodiments, the controller may be an embedded controller (EC), the flash memory may by a flash memory with a NAND structure, the host may be a south bridge chip, and the host 120 may transmit a command to the controller 130 through a low pin count (LPC) bus, but not limited to the above-mentioned in the present invention.

When the flash memory storage system 100 is started, the main power M_P and the suspension power S_P supply the power to the host 120 and the controller 130, so that the system is in a booting state. In the booting state, the host 120 transmits a command to the controller 130 to request for reading a booting program (for example, BIOS) stored in the flash memory 110 to perform a booting process. Now, the controller 130 obtains a memory address (for example, the memory address of the BIOS) of the protection block from the flash memory 110 and writes the memory address of the protection block into the register 140. After the host completes the booting process, the controller 130 returns a dominant right of the flash memory storage system 100 to a user to perform a normal usage process. Because the memory address of the protection block has been written into the register 140 by the controller 130, the controller 130 restricts the accessing of the flash memory 110 according to the memory address stored in the register 140. For example, in the present embodiment, when the user sends a control signal CTL_S to control the host to transmit a command which requests the controller 130 to access a BIOS program of the flash memory 110, the controller 130 determines the memory address requested for accessing by the command is the memory address of the protection block, and thus the controller 130 denies the access. In other words, when the controller 130 determines a target memory address which the host wants to access is the memory address of the protection block, the controller 130 denies the host 120 to access the target memory address.

FIG. 2 is a flowchart illustrating a data protection method according to the embodiment of the FIG. 1. Please referring to FIG. 1 and FIG. 2, the flash memory storage system 100 receives an access command shown in step S200. The flash memory storage system 100 determines whether the host 120 is in a booting state or in a resetting state in step S202, if the host 120 is in the booting state or in the resetting state, the host 120 is allowed for accessing the flash memory 110 (step S204); otherwise, the host 120 is restricted to access the flash memory 110 (step S212).

More specifically, the host 120 acquires the authorization of accessing the flash memory in step S204, and then obtaining the default memory address of the protection bock (step S206), and further writing the memory address of the protection block into the register 140 (step S208). Finally, the host 120 completes the following booting process or the resetting process as shown in step S210.

After the step S210, because the host has completed the booting state or the resetting state, the step S212 is the next step. In step S212, the controller 130 determines whether the target memory address of the received access command is the memory address of a protection block (step S214); if yes, the host 120 is denied to access the flash memory 110 (step S216), i.e. denying the access command; if no, the host 120 is allowed for accessing the flash memory 110 (step S218), i.e. receiving the access command and perform the following access process.

In some specific circumstances, for example, malicious users use specific methods to close the controller 130 and use other control means to avoid the protection mechanism of the controller 130, and therefore the system may occur holes. Consequently, a plurality of embodiments with flash memory storage system 100 having system protection mechanism are provided in the present invention, so as to solve the extending problem of intruding the system by malicious users.

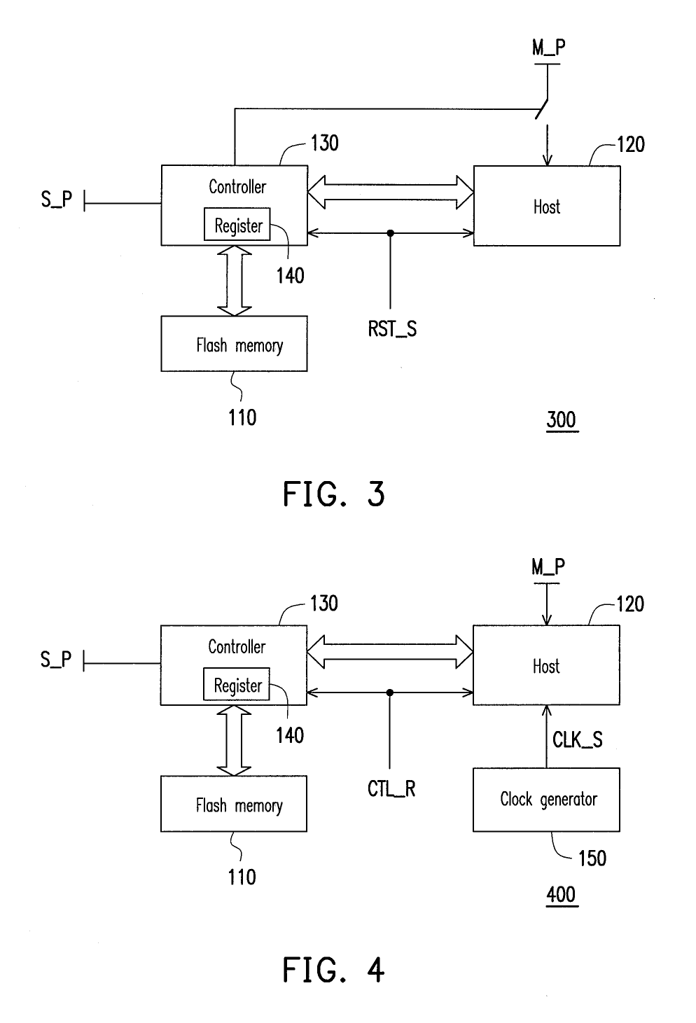

FIG. 3 is a schematic diagram of a flash memory storage system according to another embodiment of the present invention. Please referring to FIG. 3, the difference between the flash memory storage system 100 of the embodiment of the FIG. 1 and a flash memory storage system 300 is that a switch SW coupled between the main power M_P and the host 120 is added into the flash memory storage system 300 in which the conduction state is controlled by the controller 130.

When the flash memory storage system 300 is started, the controller 130 is started by the suspension power S_P first, and then the switch SW controlled by the controller 130 is turned on, so that the host 120 is started by the main power M_P to enter the booting state. Next, the host 120 transmits a requesting command of reading the flash memory 110 to the controller 130, and the controller 130 writes the memory address of the default protection block into the register 140 and performs the following booting process, where the other details have been described in the embodiment of the FIG. 1, which is omitted to describe.

In the present embodiment, the controller 130 is started by the suspension power S_P first, and then the controller 130 turns on the switch SW so that the main power M_P can start the host 120. If the controller 130 is closed, the controller 130 turns off the switch SW so that the host 120 can not be started. Once the controller 130 is closed, the host 120 will shut down and the flash memory storage system 300 can not operate, by which the specific data of the protection block of the flash memory 110 can be protected by the protection mechanism of the controller 130 in any time.

Besides, after the host 120 completes the booting process, if the user wants to reset the host 120 by giving a resetting signal RST_S, the controller 130 allows the host 120 to access the flash memory 110 according to the resetting signal RST_S, so that the host 120 can perform the resetting process. In the resetting state, similar to the booting state, the host 120 acquires the authorization of controlling the flash memory storage system 300 again, and the host 120 accesses the BIOS of the flash memory 110 by the controller 130, as described in the above-mentioned embodiment, the controller 130 writes the memory address of the default protection block into the register 140 again.

FIG. 4 is a schematic diagram of a flash memory storage system according to another embodiment of the present invention. The present method of controlling the clock generator 150 by the controller 130 prevents that the flash memory 110 can not be protected when the controller 130 is closed.

In the flash memory storage system 400 of the present embodiment, the clock generator 150 is coupled to the host 120 and provides a clock signal CLK_S for an operation of the host. Please referring to FIG. 4, the difference between the present embodiment and the embodiment of the FIG. 1 is when the controller 130 is closed by any means, the controller 130 will control the clock generator 150 to stop providing the clock signal CLK_S to the host 120 at the same time. Once the host 120 fails to receive the clock signal CLK_S, the host 120 will shut down immediately.

More specifically, when the malicious users intend to close the controller 130, the controller 130 will control the clock generator 150 to stop providing the clock signal CLK_S to the host 120, so that the host 120 can not operate, by which the specific data of the protection block of the flash memory 110 can be protected by the protection mechanism of the controller 130 in any time.

In the above-mentioned embodiments, the same feature is that the host 120 has to stop operating, once the controller 130 is closed by any means, so that the flash memory storage system has to access flash memory 110 through the controller 130, and thus the specific data of the flash memory 110 can be protected. However, the above-mentioned embodiments just represent the circumstances where the flash memory storage system 100 can not operate when the controller 130 is closed, and the present invention is not limited here.

In summary, the flash memory storage system of the embodiment of the present invention sets the specific data area within the flash memory as the protection block, so that the controller writes the memory address of the protection block into the register and performs the access restrictions. In the embodiment of the present invention, the flash memory storage system operates only when the controller is started, whereas the host stop operating when the controller is closed. Accordingly, the system will be protected by the access restrictions of the controller in any operation time.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A flash memory storage system, comprising:
a flash memory;
a host; and
a controller, coupled to the host and the flash memory, restricting the host to access the flash memory according to a state of the host, wherein when the host is in a booting state or in a resetting state, the controller allows the host to access the flash memory, after the host completes a booting process or a resetting process, the controller restricts the host to access the flash memory.

2. The flash memory storage system as claimed in claim 1, further comprising:
a switch, coupled between a main power and the host, turning on the switch according to a suspension power to supply the main power to the host.

3. The flash memory storage system as claimed in claim 2, wherein when the controller is closed, the controller turns off the switch to stop supplying the main power to the host.

4. The flash memory storage system as claimed in claim 3, wherein when the host is in a resetting state controlled by a resetting signal, the controller allows the host to access the flash memory according to the resetting signal.

5. The flash memory storage system as claimed in claim 1, further comprising:
a clock generator, coupled to the host, providing a clock signal for an operation of the host, wherein when the controller is closed, the clock generator stops providing the clock signal to the host.

6. The flash memory storage system as claimed in claim 1, wherein the controller comprises:
at least a register, storing a memory address of a protection block of the flash memory, the controller further obtains the memory address of the protection block from the flash memory and writes the memory address of the protection block into the register.

7. The flash memory storage system as claimed in claim 6, wherein the controller further determines whether a target memory address which the host wants to access is the memory address of the protection block, if the target memory address is the memory address of the protection block, the controller denies the host to access the target memory address.

8. A data protection method for a flash memory storage system, wherein the flash memory storage system comprises a host and a flash memory, the data protection method comprises:
determining whether the host is in a booting state or in a resetting state;
allowing the host to access the flash memory, if the host is in the booting state or in the resetting state; and
restricting the host to access the flash memory, if the host is not in the booting state or in the resetting state.

9. The data protection method for the flash memory storage system as claimed in claim 8, wherein the step of restricting the host to access the flash memory further comprises:
determining whether a target memory address which the host wants to access is a memory address of a protection block;
denying the host to access the target memory address, if the target memory address is the memory address of the protection block; and
allowing the host to access the target memory address, if the target memory address is not the memory address of the protection block.

10. The data protection method for the flash memory storage system as claimed in claim 8, wherein the flash memory storage system further comprises a register, the step of the host is in the booting state or in the resetting state further comprises:
obtaining a memory address of a protection block; and
writing the memory address of the protection block into the register.
